(19) United States
(12) Patent Application Publication
(10) Pub. No.: US 2025/0242611 A1
(43) Pub. Date: Jul. 31, 2025

(54) PRINTER

(71) Applicant: BROTHER KOGYO KABUSHIKI KAISHA, Nagoya (JP)

(72) Inventor: Yuya TAGAMI, Owariasahi (JP)

(21) Appl. No.: 19/041,389

(22) Filed: Jan. 30, 2025

(30) Foreign Application Priority Data
Jan. 31, 2024 (JP) 2024-012676

(51) Int. Cl. B41J 11/14; B41J 11/00; B41J 11/04; B41J 29/393; G01P 3/481; H02P 6/17; H02P 6/24

(52) U.S. Cl. CPC B41J 11/14; B41J 11/0095; B41J 11/04; B41J 29/393; G01P 3/481; H02P 6/17; H02P 6/24

(57) ABSTRACT

The printer includes a head, a platen roller, a drive gear, a DC motor, a processor, and a memory. The head is configured to perform, using power from a battery, printing on a medium. The platen roller is configured to transport the medium. The drive gear is configured to drive the platen roller. The DC motor is configured to be rotated by the power from the battery, and drive the drive gear. The memory stores computer-readable instructions. The instructions instruct the processor to perform processes. The processes include detecting, N times, a detection signal corresponding to a rotational speed of the DC motor, N being a positive number of 2 or more. The processes include calculating an N−1th fluctuation parameter calculated based on the detected N−1th detection signal. The processes include determining a relationship between the calculated N−1th fluctuation parameter and the detected Nth detection signal.

### REFERENCE TO RELATED APPLICATIONS

This application claims priority from Japanese Patent Application No. 2024-012676 filed on Jan. 31, 2024. The entire content of the priority application is incorporated herein by reference.

### BACKGROUND ART

The present disclosure relates to a printer.

A motor control device suppresses damage to a gear connected to a DC motor. The motor control device includes a detection portion, a determination portion, and a motor controller. The detection portion detects a rotational speed of the DC motor. The determination portion determines whether the detected rotational speed is less than a lower limit rotational speed. The motor controller stops the DC motor when the detected rotational speed falls below the lower limit rotational speed.

### SUMMARY

In the above-described motor control device, variations in the rotational speed of the DC motor may occur, for example, due to fluctuations in battery voltage. For example, the rotational speed of the DC motor may fall below a lower limit rotational speed due to a decrease in the battery voltage. In this case, the DC motor control device ends up stopping the DC motor even if the gear is unlikely to be damaged.

Various embodiments of the general principles described herein provide a printer that contributes to appropriately suppressing damage to the gear connected to the DC motor even when the battery voltage fluctuates.

Embodiments herein provide a printer driven by a battery. The printer includes a head, a platen, a drive gear, a DC motor, a processor, and a memory. The head is configured to perform, using power from the battery, printing on a medium. The platen roller is configured to transport the medium. The drive gear is configured to drive the platen roller. The DC motor is configured to be rotated by the power from the battery, and drive the drive gear. The memory stores computer-readable instructions that, when executed by the processor, instruct the processor to perform processes. The processes include detecting, N times, a detection signal corresponding to a rotational speed of the DC motor. N is a positive number of 2 or more. The processes include calculating an N−1th fluctuation parameter calculated based on the detected N−1th detection signal. The processes include determining a relationship between the calculated N−1th fluctuation parameter and the detected Nth detection signal.

The above-described printer does not determine the detection signal in relation to a fixed value, but rather determines the relationship with the N-th detection signal on the basis of the N−1th fluctuation parameter calculated on the basis of the N−1th detection signal. Therefore, the printer is less likely to be affected by fluctuations in the rotational speed of the DC motor due to fluctuations in the battery voltage, for example. Therefore, the printer contributes to appropriately suppressing damage to the gear connected to the DC motor even when the battery voltage fluctuates.

### BRIEF DESCRIPTION OF DRAWINGS

FIG. 1 is a perspective view of a printer.

FIG. 2 is a perspective view of the printer with a back cover removed.

FIG. 3 is a perspective view of a print unit.

FIG. 4 is a perspective view of a tape cassette.

FIG. 5 is a block diagram of the electrical configuration of the printer.

FIG. 6 is a view of the characteristics of a DC motor.

FIG. 7 is a view illustrating the relationship between a threshold value and a detection signal.

FIG. 8 is a flowchart of main processing.

FIG. 9 is a view of the relationship between fluctuation parameters and the detection signal.

### DESCRIPTION

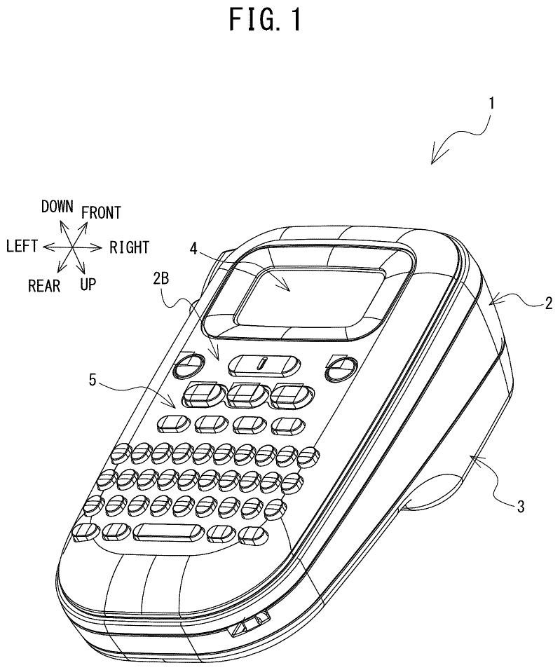

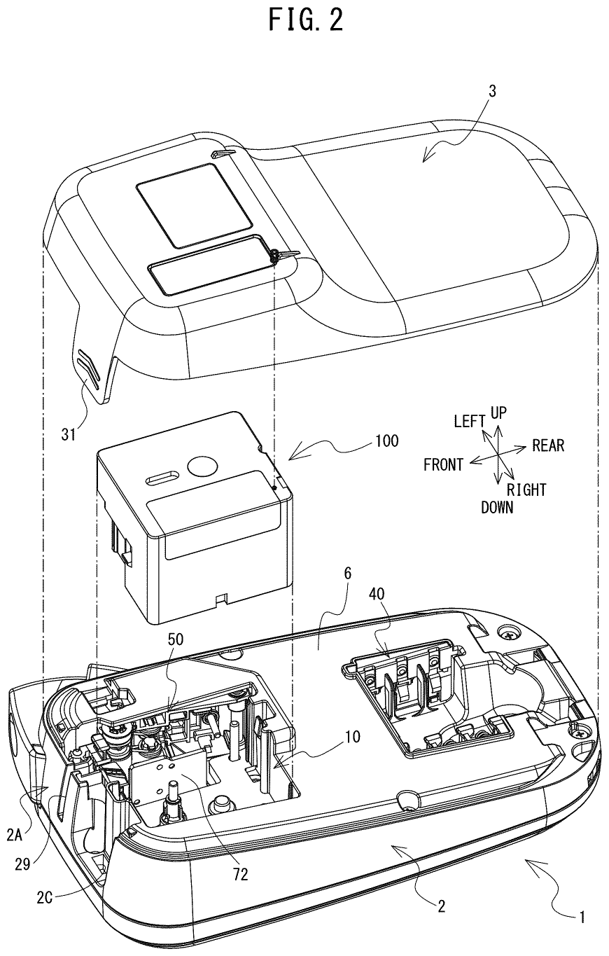

An embodiment of the present disclosure will be described with reference to the drawings. An overview of a printer 1 will be described with reference to FIGS. 1 and 2. The drawings are used to illustrate the technical features that can be adopted by the present disclosure. That is, configurations and the like in the drawings are not intended to limit the present disclosure, and are merely explanatory examples. In the description of the present embodiment, upper left portion, lower right portion, right portion, left portion, upper right portion, and lower left portion in FIG. 1 are a top, an bottom, a right, a left, a front, and a rear, respectively, of the printer 1.

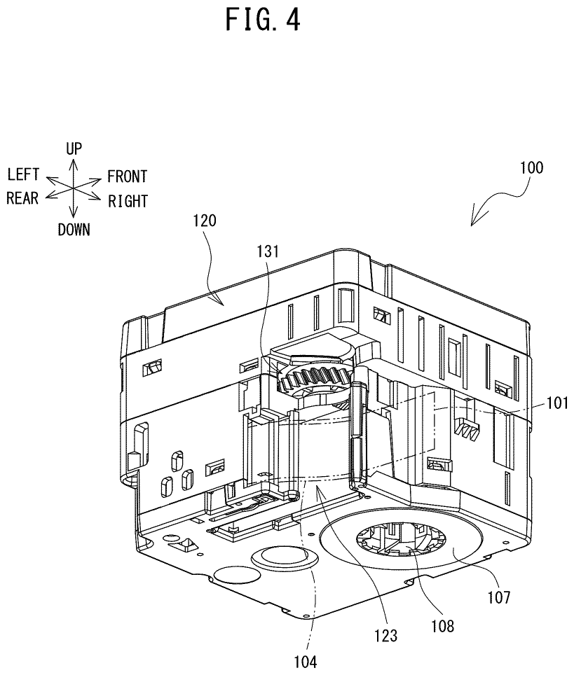

The configuration of the printer 1 will be described. As shown in FIGS. 1, and 2, the printer 1 is a portable label printer. The printer 1 is powered by a battery housed in a battery compartment 40. The printer 1 can create a label in which an image is printed on a tape 101 (refer to FIG. 4) pulled off of a tape cassette 100. An image of a character, a figure, or the like is printed on the label.

As shown in FIGS. 1 and 2, the printer 1 includes a housing 2, a back cover 3, a display portion 4, and an input portion 5. The housing 2 has a long box shape in the front-rear direction, and the back surface opens. An inner cover 6 is assembled to the open portion to protect the interior of the housing 2. A discharge path 29 that passes through in the front-rear direction, and a retaining hole 2C that engages with an opening/closing portion 31 of the back cover 3 are formed in a top wall 2A of the housing 2.

The back cover 3 is removably attached to the housing 2. The back cover 3 extends in the front-rear direction and has a recessed shape that is recessed upward. When attached, the back cover 3 covers the entire back of the housing 2, covering the opening of the back and the entire inner cover 6.

The display portion 4 is provided at a position farther toward the front than the center in the front-rear direction of a lower surface 2B of the housing 2. The display portion 4 is, for example, a liquid crystal display, and can display various kinds of information. The input portion 5 is provided to the rear portion of the display portion 4, on the lower surface 2B of the housing 2. The input portion 5 includes a plurality of keys, such as a character key, a print button, and an Esc key. The input portion 5 receives input of various kinds of information by a user operation. The user operates the display portion 4 and the input portion 5 to edit print data.

As shown in FIG. 2, the printer 1 includes a cassette compartment 10, the battery compartment 40, and a print unit 50 inside the housing 2. The cassette compartment 10 removably accepts the tape cassette 100. The cassette compartment 10 is formed, inside the inner cover 6 on the back of the housing 2, at a position frontward from the center of the inner cover 6 in the front-rear direction. The cassette compartment 10 is recessed downward.

The battery compartment 40 houses a battery. The battery compartment 40 is formed in a recessed shape recessed downward in the inner cover 6 on the back of the housing 2, at a position rearward of the center in the front-rear direction of the housing 2. The user can replace both the tape cassette 100 and the battery while the back cover 3 is removed from the housing 2.

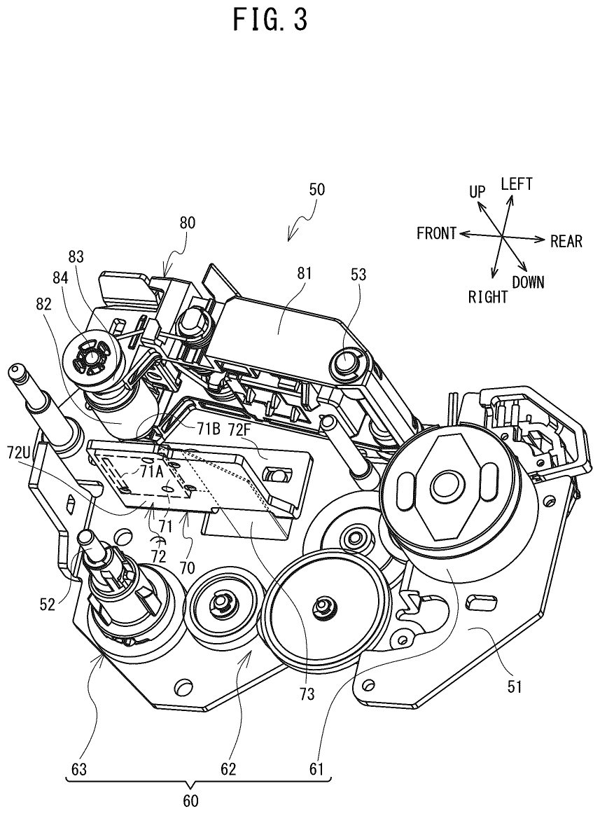

The print unit 50 is a unit configured to perform printing on the tape 101. The print unit 50 is disposed at a front portion inside the housing 2, below a left end portion of the cassette compartment 10. As shown in FIG. 3, the print unit 50 includes a head unit 70, a platen unit 80, and a drive mechanism 60, and the like.

As shown in FIG. 3, the head unit 70 is assembled to a base 51. The head unit 70 includes a heat sink 72 and a head 71. The heat sink 72 is disposed in a central portion in the left-right direction, of a front end portion of the base 51. The heat sink 72 is a metal plate for holding the head 71 and for dissipating heat. The heat sink 72 includes a lower end portion 72F and a right end portion 72U. The lower end portion 72F faces the plate surface in the up-down direction and extends longer in the front-rear direction than in the left-right direction. The lower end portion 72F is fixed to the base 51 with screws. The right end portion 72U extends upward from the right end of the lower end portion 72F. The right end portion 72U faces the plate surface in the left-right direction and extends longer in the front-rear direction than in the up-down direction.

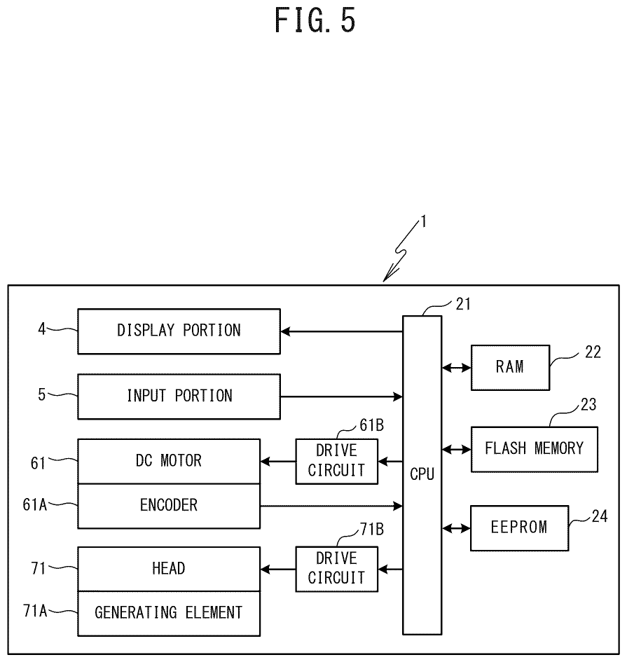

The head 71 is fixed to a left surface of the right end portion 72U of the heat sink 72 with an adhesive. The head 71 is a rectangular circuit board containing a plurality of heat generating elements 71A and a drive circuit 71B. The plurality of heat generating elements 71A are arranged lined up in the up-down direction on a front end portion of the left surface of the substrate. The drive circuit 71B is formed on a rear end portion of the left surface of the substrate and electrically connects with a CPU 21 (refer to FIG. 5) in the housing 2 via a harness 73. The head 71 performs printing on the tape 101 using the power of the battery.

The platen unit 80 is disposed on the left portion of the base 51. The platen unit 80 is swingably supported by a rotation shaft 53 at a rear end portion of the platen unit 80. Thus, the front end portion of the platen unit 80 can swing in the left-right direction. The rotation shaft 53 of the platen unit 80 is provided on a rear-left end portion of the base 51 and extends upward. By the swinging of the platen unit 80, a platen roller 82 can swing between a close position close to the head 71 (not shown in the drawings) and a separated position separated from the head 71 (refer to FIG. 3).

The platen unit 80 includes a platen holder 81, a platen shaft 84, a platen roller 82, and a platen gear 83. The platen holder 81 has a box shape that is long in the front-rear direction and in which the right portion of the platen holder 81 is open. A rotation shaft 52 is inserted through a rear end portion of the platen holder 81. The platen roller 82 is rotatably supported at the front end portion of the platen holder 81.

The platen gear 83 is fixed to an upper end of the platen shaft 84. The platen gear 83 is a so-called helical gear in which the gear teeth are set at a predetermined angle with respect to the axial center of rotation. The platen gear 83 meshes with an output gear 131 (refer to FIG. 4) of the tape cassette 100. The driving force of a drive shaft 63 is input to the platen roller 82 via the output gear 131 and the platen gear 83. The platen roller 82 sandwiches the tape 101 and an ink ribbon 104 with the head 71 at a head opening 123 (refer to FIG. 4). The platen roller 82 transports the tape 101 toward the discharge path 29 by the axial rotation of the platen roller 82.

The drive mechanism 60 is provided with a DC motor 61, a gear set 62, and the drive shaft 63, and is assembled to the base 51. The DC motor 61 is driven by the power of the battery. The DC motor 61 is a drive source and is disposed at a rear end portion of the base 51. The DC motor 61 is coupled to the gear set 62 in which a plurality of gears are connected. The gear set 62 is coupled to the drive shaft 63. The DC motor 61, the gear set 62, and the base 51 are disposed below the inner cover 6 inside the housing 2.

The drive shaft 63 is disposed on a front-right end portion of the base 51. The drive shaft 63 is inserted through the rotation shaft 52 provided on the base 51. Driving force transmitted from the DC motor 61 is input to the drive shaft 63 via the gear set 62. Accordingly, the drive shaft 63 rotates about the rotation shaft 52.

The tape cassette 100 will now be described with reference to FIG. 4. The user can replenish the tape 101 and change the type (e.g., size, color, material, etc.) of the tape 101 by replacing the tape cassette 100. The tape cassette 100 includes a main case 120. The main case 120 has a cuboid shape. The tape 101 and the ink ribbon 104 are housed inside the main case 120. The tape 101 and the ink ribbon 104 are wound in a roll shape inside the main case 120.

A winding spool 107 is provided on a front lower portion of the main case 120. A lower end of the winding spool 107 is exposed downward from the main case 120. The winding spool 107 has a cylindrical shape and has an inner peripheral surface 108. The axial center of rotation of the winding spool 107 is parallel to the axial center of rotation of a ribbon spool (not shown in the drawings) around which the ink ribbon 104 is wound. When the tape cassette 100 is installed in the cassette compartment 10, the drive shaft 63 is inserted into the inner peripheral surface 108. The winding spool 107 is rotated by the drive shaft 63. The ink ribbon 104 is transported from the ribbon spool (not shown in the drawings) toward the head opening 123. The ink ribbon 104 that has passed through the head opening 123 is wound up onto the winding spool 107.

The output gear 131 is provided in a center portion in the up-down direction, and is positions away from the winding spool 107 to the upper left. The output gear 131 is exposed to the left from the main case 120. The axial center of rotation of the output gear 131 is the same as the axial center of rotation of the winding spool 107. The output gear 131 meshes with the platen gear 83 (refer to FIG. 3) when the platen roller 82 (refer to FIG. 3) is in the close position (not shown in the drawings).

The output gear 131 is connected to a drive transmission mechanism (not shown in the drawings) disposed in the main case 120. The drive transmission mechanism (not shown in the drawings) is connected to the output gear 131 and is connected to an upper end portion of the drive shaft 63 inserted into the winding spool 107. The drive transmission mechanism (not shown in the drawings) is made up of a plurality of gears, for example. As the drive shaft 63 rotates, the drive transmission mechanism (not shown in the drawings) transmits the driving force to the output gear 131. This causes the platen gear 83 to rotate, which in turn causes the platen roller 82 to rotate. The platen roller 82 transports the tape 101. Therefore, in the tape cassette 100, the tape 101 and the ink ribbon 104 are transported by the rotation of the drive shaft 63.

The electrical configuration of the printer I will now be described with reference to FIG. 5. The printer 1 further includes the CPU 21, RAM 22, flash memory 23, an EEPROM 24, and drive circuits 61B and 71B, and the like. The CPU 21 controls the printer 1. The CPU 21 is electrically connected to the RAM 22, the flash memory 23, the EEPROM 24, the drive circuits 61B and 71B, the display portion 4, and the input portion 5.

The RAM 22 temporarily stores various data. The flash memory 23 stores various programs that the CPU 21 executes to control the printer 1. In the EEPROM 24, dot pattern data for printing is classified and stored according to typeface and size.

The drive circuit 61B drives the DC motor 61 in accordance with instructions from the CPU 21. An encoder 61A is provided in the DC motor 61. The encoder 61A outputs a pulse indicating a rotational position of the DC motor 61. The pulse output from the encoder 61A is output to the CPU 21. The drive circuit 71B selectively heats the heat generating element 71A of the head 71 in accordance with the instructions from the CPU 21.

The display portion 4 displays various information in accordance with the instructions from the CPU 21. The input portion 5 transmits various instructions input by the user to the CPU 21.

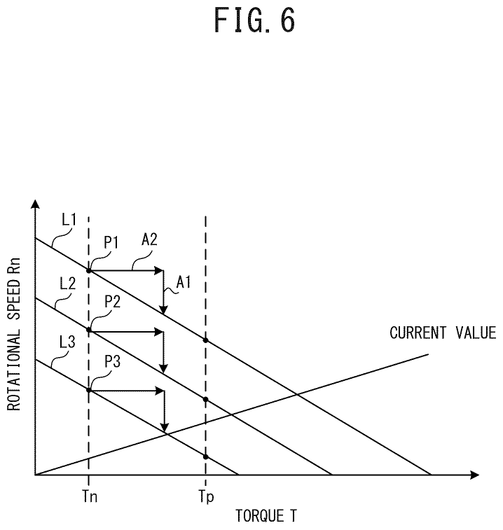

The relationship between rotational speed Rn and torque T of the DC motor 61 will now be described with reference to FIG. 6. The rotational speed Rn along the vertical axis indicates the rotational speed of the DC motor 61. The torque T along the horizontal axis indicates the force for rotating a shaft of the DC motor 61. For example, a straight line L1 shows the characteristics of a state in which the battery is in good condition and the battery voltage is high. A straight line L2 shows the characteristics of a state in which the battery is normal and the battery voltage is medium. A straight line L3 shows the characteristics of a state in which the battery is degraded and the battery voltage is low.

The higher the torque T, the lower the rotational speed Rn of the DC motor 61. The lower the torque T, the higher the rotational speed Rn of the DC motor 61. Further, the rotational speed Rn of the DC motor 61 changes in accordance with the battery voltage of the battery. For example, when viewed in terms of torque Tn, the rotational speed Rn of the DC motor 61 decreases as the battery voltage decreases (refer to intersection points P1, P2, and P3).

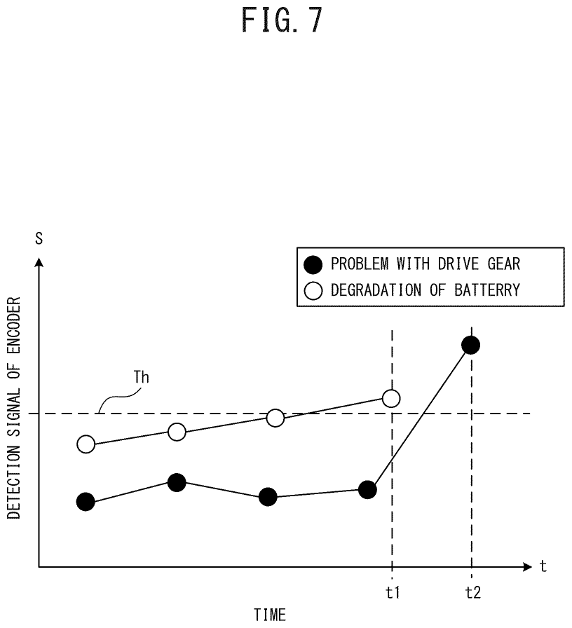

Stopping of the DC motor 61 to prevent damage to the gears will be described with reference to FIGS. 6 and 7. For example, let us assume that a problem has occurred for some reason with the gear set 62, the drive transmission mechanism (not shown in the drawings), the output gear 131, or the platen gear 83 (hereinafter also collectively referred to as “drive gears”), or the like, which transmit the driving force to the platen roller 82. With the straight line L1, for example, the rotational speed Rn of the DC motor 61 decreases (refer to arrow A1). In this case, the torque T of the DC motor 61 increases from the torque Tn (refer to arrow A2). If the rotational speed Rn of the DC motor 61 continues to decrease, the torque T of the DC motor 61 will reach a threshold torque Tp. In this case, the drive gear connected to the DC motor 61 will be damaged. Note that in the case in which the battery has degraded from when it was new (straight line L2 and straight line L3) as well, the torque T will similarly increase as the rotational speed Rn decreases. Therefore, it is necessary to stop the DC motor 61 before the torque T of the DC motor 61 reaches the threshold torque Tp.

As shown in FIG. 7, the printer 1 compares, for example, a detection signal S of the encoder 61A of the DC motor 61 with a threshold value Th to determine whether to stop driving the DC motor 61 in order to prevent damage to the drive gear. When the detection signal S of the encoder 61A exceeds the threshold value Th, the printer 1 stops the DC motor 61. Here, the detection signal S of the encoder 61A corresponds the time until the output of the encoder 61A for 18 pulses is detected, for example. In other words, the detection signal S is a signal corresponding to the rotational speed Rn of the DC motor 61. When the rotational speed Rn of the DC motor 61 decreases, the detection signal S of the encoder 61A increases. Also, when the rotational speed Rn of the DC motor 61 decreases, the torque T of the DC motor 61 increases. Therefore, an increase in the detection signal S of the encoder 61A means an increase in the torque T of the DC motor 61.

The threshold value Th is a fixed value. For example, let us assume that the threshold value Th is a value based on the threshold torque Tp at which the gear will be damaged. For example, the detection signal S of the encoder 61A will exceed the threshold value Th at the time t2 when a problem has occurred with the driving of the drive gear. In this case, the driving of the DC motor 61 is stopped.

On the other hand, it is expected that the battery will degrade and the battery voltage will decrease due to continued use (for example, the straight line L3 in FIG. 6). In this case, the rotational speed Rn of the DC motor 61 decreases, so the torque T of the DC motor 61 increases (refer to FIG. 6). In other words, the detection signal S also increases due to degradation of the battery, as well as due to the problem with the drive gear. The detection signal S exceeds the threshold value Th at time t1 due to the decrease in the battery voltage. As a result, the driving of the DC motor 61 is stopped. In other words, the driving of the DC motor 61 is stopped even if there is no problem with the drive gear.

In order to deal with such a case, it is necessary to set a threshold value higher than the threshold value Th shown in FIG. 7. However, if the threshold value Th is set too high, it may not be possible to detect a problem with the driving of the drive gear. Therefore, in order to appropriately stop the DC motor 61 so as to prevent damaging the gear, it may be problematic to have the threshold value Th be a fixed value.

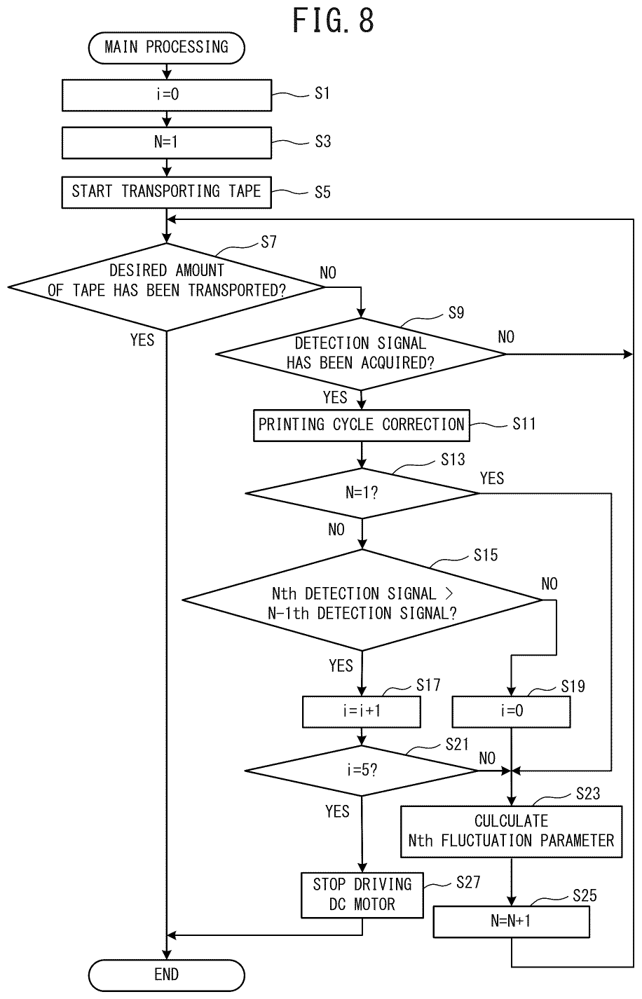

Main processing will be described with reference to FIG. 8. For example, the print data is edited by the user, and the print execution button is pressed. In this case, the CPU 21 reads and executes a program from the flash memory 23. When the program is executed, the CPU 21 starts the main processing.

When the main processing is started, the CPU 21 sets i to 0 (S1). The CPU 21 sets N to 1 (S3). The CPU 21 starts transporting the tape 101 (S5). The CPU 21 determines whether a desired amount of tape 101 has been transported (S7). Here, the desired amount is the amount of the tape 101 that has been transported (hereinafter, this amount will also be referred to as the “transport amount”) at the time printing is complete. The desired amount can be identified on the basis of the print data. Note that the transport amount is specified on the basis of the number of pulses of the encoder 61A of the DC motor 61.

When it is determined that the desired amount of tape 101 has not been transported (no at S7), the CPU 21 determines whether the Nth detection signal S has been acquired (S9). When it is determined that the detection signal S has not been acquired (no at S9), in other words, when the output for 18 pulses has not been detected, the CPU 21 returns the processing to step S7.

When it is determined that the Nth detection signal S has been acquired (yes at S9), the CPU 21 performs a printing cycle correction to correct the printing operation (S11). The printing cycle correction is a process of reducing enlargement or reduction of the image by correcting the transport speed of the tape 101. The CPU 21 performs the printing cycle correction at a predetermined cycle. The predetermined cycle is the timing at which a signal for 18 pulses from the encoder 61A is acquired.

The CPU 21 determines whether N is set to 1 (S13). When it is determined that Nis set to 1 (yes at S13), the CPU 21 calculates an Nth fluctuation parameter Pth on the basis of the Nth detection signal S acquired in step S9 (S23). In this case, since N is 1, the first fluctuation parameter Pth is calculated on the basis of the first detection signal S.

The fluctuation parameter Pth is a threshold value that fluctuates with each output of the 18 pulses of the encoder 61A. For example, the CPU 21 calculates the Nth fluctuation parameter Pth by multiplying the detected Nth detection signal S by a predetermined ratio. The predetermined ratio shall be set in advance. The predetermined ratio is, for example, 1.5.

The CPU 21 increases N in increments of 1 (S25). For example, N is set from 1 to 2. The CPU 21 then returns the processing to step S7. Thereafter, the CPU 21 detects a second detection signal S (yes at S9), and the CPU 21 performs the printing cycle correction (S11).

When it is determined that N is not 1, that is, when N is set to a value of 2 or more (no at S13), the CPU 21 determines whether the Nth detection signal S exceeds the N−1th fluctuation parameter Pth (S15). In other words, the CPU 21 determines a relationship between the calculated N−1th fluctuation parameter Pth and the detected Nth detection signal S. Note that the processing at step S15 is performed after the processing at step S11. In other words, the processing at step S15 is synchronized to a predetermined cycle of the printing cycle correction.

When it is determined that the Nth detection signal S does not exceed the N−1th fluctuation parameter Pth (no at S15), the CPU 21 determines that there is no problem with the detection signal S and initializes to i=0 (S19). The CPU 21 advances the processing to step S23 and calculates the Nth fluctuation parameter Pth on the basis of the Nth detection signal S (S23).

When it is determined that the Nth detection signal S exceeds the N−1th fluctuation parameter Pth (yes at S15), the CPU 21 increases i in increments of 1 (S17). The CPU 21 determines whether i is set to 5 (S21). When it is determined that i is not set to 5 (no at S21), the CPU 21 advances the processing on to step S23 and calculates the Nth fluctuation parameter Pth on the basis of the Nth detection signal S (S23).

On the other hand, if it is determined that i is set to 5 (yet at S21), the CPU 21 stops driving the DC motor 61 because the driving gear may become damaged (S27). Thus, the transportation of the tape 101 is stopped. Note that when the determination of yes at S15 is consecutive in the processing at step S15, i continues to be increased incrementally. On the other hand, when the determination is no at S15 while i is being incrementally increased, i is initialized to 0. Therefore, when i is set to 5, a determination of yes at S15 must be made five times in a row. In other words, when the CPU 21 determines that the detection signal S has exceeded the fluctuation parameter Pth for a plurality of times (five times) in a row, the CPU 21 stops driving the DC motor 61. The CPU 21 then terminates the main processing.

On the other hand, when it is determined that the desired amount of tape 101 has been transported (yes at S7), printing is complete, so the CPU 21 ends the main processing.

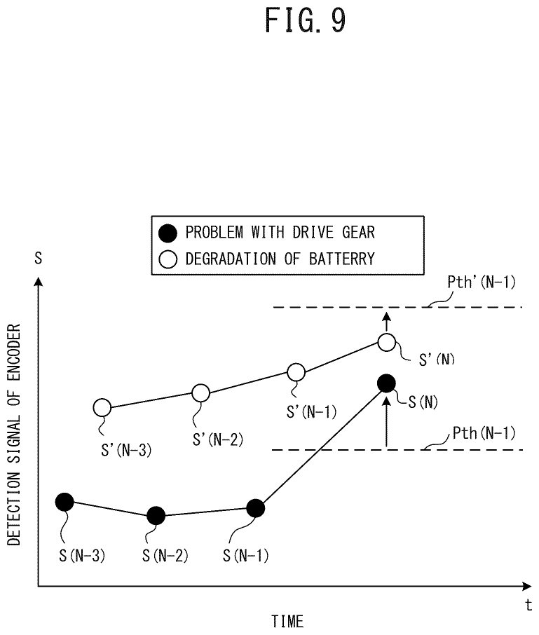

When the main processing is executed, it becomes possible to detect as shown in FIG. 9 for example. For example, if the detection signal S(N) exceeds a fluctuation parameter Pth(N−1) due to a problem with the drive gear, the drive of the DC motor 61 is stopped. As a result, damage to the drive gear can be suppressed. On the other hand, since a fluctuation parameter Pth′(N−1) is calculated from a detection signal S′(N−1), a comparison is made with the fluctuation parameter Pth′(N−1) taking into account the decrease in the battery voltage. Therefore, unlike the example shown in FIG. 7, the possibility of the DC motor 61 being stopped due to a decrease in the battery voltage is reduced.

As described above, the CPU 21 calculates the N−1th fluctuation parameter Pth on the basis of the detected N−1th detection signal S. The CPU 21 determines a relationship between the calculated N−1th fluctuation parameter Pth and the detected Nth detection signal S.

Rather than determining the detection signal S in relation to a fixed value, the above printer 1 determines the relationship with the Nth detection signal S on the basis of the N−1th fluctuation parameter Pth, which is calculated on the basis of the N−1th detection signal S. Therefore, the printer 1 is less susceptible to fluctuations in the rotational speed of the DC motor 61 due to fluctuations in the battery voltage, for example. Therefore, the printer 1 contributes to appropriately suppressing damage to the gear connected to the DC motor 61 even when the battery voltage fluctuates.

The CPU 21 determines whether the detection signal S exceeds the fluctuation parameter Pth. When the CPU 21 determines that the detection signal S exceeds the fluctuation parameter Pth, the CPU 21 stops driving the DC motor 61. Since the printer 1 determines the relationship of the detection signal S in relation to the fluctuation parameter Pth, the printer contributes to reducing the possibility of accidentally stopping the DC motor 61.

When the CPU 21 determines that the detection signal S has exceeded the fluctuation parameter Pth a plurality of times in a row, the CPU 21 stops driving the DC motor 61. The printer 1 is able to make a determination that is not easily affected by fluctuations in the battery voltage. Thus the printer contributes to further reducing the possibility of accidentally stopping the DC motor 61.

The encoder 61A is provided in the DC motor 61. The CPU 21 detects the output result of the encoder 61A as the detection signal S. The printer 1 contributes to detecting the detection signal S without separately providing a sensor.

The CPU 21 executes the printing cycle correction that corrects the printing operation at a predetermined cycle. The CPU 21 determines a relationship between the detection signal S and the fluctuation parameter Pth in synchronization with a predetermined cycle during which the printing operation is corrected. The printer 1 contributes to reducing the load on the CPU 21 by synchronizing the determination of the relationship between the detection signal S and the fluctuation parameter Pth with the correction of the printing operation.

The CPU 21 calculates the Nth fluctuation parameter Pth by multiplying the detected Nth detection signal S by a predetermined ratio. The printer 1 contributes to calculating the fluctuation parameter Pth by a simple operation.

In the above description, the tape 101 and the ink ribbon 104 are examples of the “medium” of the present disclosure. The gear set 62, the drive transmission mechanism, the output gear 131, and the platen gear 83 are examples of the “drive gear” of the present disclosure. The CPU 21 is an example of the “controller” of the present disclosure. The processing at step S9 executed by the CPU 21 is an example of the “detection processing” of the present disclosure. The processing at step S23 executed by the CPU 21 is an example of the “calculation processing” of the present disclosure. The processing at step S15 executed by the CPU 21 is an example of the “determination processing” of the present disclosure. The processing at step S27 executed by the CPU 21 is an example of the “stopping processing” of the present disclosure. The processing at step S11 executed by the CPU 21 is an example of the “correction processing” of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The present disclosure is not limited to the above-described embodiments and the like; various further modifications are possible. The features disclosed in the above-described embodiments and modified examples can be combined so long as they are not contradictory. The printer 1 is a thermal-type printer, but the disclosure is not limited to this. The printer 1 may alternatively employ an inkjet system. The printer 1 is powered by a battery, but the disclosure is not limited to this. An AC adapter may be used as an external power supply. The present disclosure is also effective in the case where the voltage decreases due to degradation of the AC adapter.

In the above-described embodiment, the CPU 21 multiplies the Nth detection signal S by a predetermined ratio, but the disclosure is not limited to this. For example, the CPU 21 may alternatively calculate the N−1th fluctuation parameter Pth by adding a predetermined additional value to the detected N−1th detection signal S. The printer 1 contributes to calculating the fluctuation parameter Pth by a simple operation.

In the above-described embodiment, the detection signal S is the time it takes to detect 18 pulses of the encoder 61A, but the disclosure is not limited to this. For example, a sensor may alternatively be used to detect the detection signal S. The sensor is provided in the transport path of the tape 101 to detect the presence or absence of the tape 101. The sensor may be a transmissive sensor or a reflective sensor. The tape 101 has, for example, indications (e.g., marks, holes) arranged at predetermined intervals. In this case, the CPU 21 detects, as the detection signal S, the detection cycle of the indications with the sensor. The printer 1 contributes to accurately detecting the detection signal S with the sensor.

In the above-described embodiment, the detection signal S and the fluctuation parameter Pth are based on the time it takes to detect 18 pulses, but the disclosure is not limited to this. For example, a number of pulses other than 18 may be used as a reference upon which the detection signal S and the fluctuation parameter Pth are based. In other words, the number of pulses may be less than 18 or more than 18. Therefore, it is not necessary to synchronize with the printing cycle correction. Further, the detection signal S and the fluctuation parameter Pth may be values based on the torque T or values based on the rotational speed Rn. The predetermined ratio, additional value, and the like, used in the calculation of the fluctuation parameter Pth may be changed as appropriate.

In the above-described embodiment, the first detection signal S is not used to stop the DC motor 61, but the disclosure is not limited to this. For example, the first detection signal S may be compared with the threshold value Th determined in advance.

In the above-described embodiment, when i=5, in other words, when the detection signal S exceeds the fluctuation parameter Pth five times in a row, the drive of the DC motor 61 is stopped, but the disclosure is not limited to this. For example, the DC motor 61 may be stopped when i becomes a positive number of 4 or less, or the DC motor 61 may be stopped when i becomes a positive number of 6 or more.

An ASIC, FPGA (Field Programmable Gate Array), or the like may be used as the processor instead of the CPU 21. The main processing may be decentralized processing performed by a plurality of processors. The printer 1 may include, for example, another non-transitory storage medium such as an HDD. The non-transitory storage medium need only be a storage medium capable of retaining information regardless of the period for which the information is stored. The non-transitory storage medium need not include a temporary storage medium (e.g., a signal to be transmitted).

Various programs may, for example, be downloaded from a server connected to a network not shown in the drawings (i.e., transmitted as a transmission signal) and stored in a memory such as an HDD. In this case, the various programs may be stored in a non-transitory storage medium such as an HDD provided in the server.

What is claimed is:

1. A printer driven by a battery, the printer comprising:
a head configured to perform, using power from the battery, printing on a medium;
a platen roller configured to transport the medium;
a drive gear configured to drive the platen roller;
a DC motor configured to be rotated by the power from the battery, and drive the drive gear;
a processor, and a memory storing computer-readable instructions that, when executed by the processor, instruct the processor to perform processes comprising:
detecting, N times, a detection signal corresponding to a rotational speed of the DC motor, N being a positive number of 2 or more;
calculating an N−1th fluctuation parameter calculated based on the detected N−1th detection signal; and
determining a relationship between the calculated N−1th fluctuation parameter and the detected Nth detection signal.

2. The printer according to claim 1, wherein
the determining includes determining whether the detection signal exceeds the fluctuation parameter, and
the computer-readable instructions, when executed by the processor, further instruct the processor to perform a process comprising:
stopping the driving of the DC motor in response to determining that the detection signal exceeds the fluctuation parameter.

3. The printer according to claim 2, wherein
the stopping includes stopping the driving of the DC motor when it is determined that the detection signal has exceeded the fluctuation parameter a plurality of times in a row.

4. The printer according to claim 1, wherein
the DC motor is provided with an encoder, and
the detecting includes detecting an output result of the encoder as the detection signal.

5. The printer according to claim 1, wherein
the computer-readable instructions, when executed by the processor, further instruct the processor to perform a process comprising:
correcting a printing operation at a predetermined cycle, and
the determining includes determining a relationship between the detection signal and the fluctuation parameter in synchronization with the predetermined cycle.

6. The printer according to claim 1, wherein
the calculating includes calculating the N−1th fluctuation parameter by multiplying the detected N−1th detection signal by a predetermined ratio.

7. The printer according to claim 2, wherein
the calculating includes calculating the N−1th fluctuation parameter by adding a predetermined additional value to the detected N−1th detection signal.

8. The printer according to claim 1, further comprising:
a sensor provided in a transport path of the medium,
wherein the medium includes an indication arranged at predetermined intervals, and
wherein the detecting includes detecting, as the detection signal, a detection cycle of the indication with the sensor.
